(19) United States
(12) Patent Application Publication
(10) Pub. No.: US 2012/0228905 A1
(43) Pub. Date: Sep. 13, 2012

(54) Gap cover folder

(76) Inventor: Raul Miguel Arizpe, El Paso, TX (US)

(21) Appl. No.: 13/136,522

(22) Filed: Aug. 4, 2011

Related U.S. Application Data
(60) Provisional application No. 61/464,596, filed on Mar. 7, 2011.

(51) Int. Cl. B60N 3/00; B60N 2/44

(52) U.S. Cl. 297/182

(57) ABSTRACT

A motor vehicle accessory that is very useful in solving the problem of people dropping items in the gap between the bucket seat and console of trucks or cars. The product will be sold in pairs and will be placed in the gap between the bucket seats of the driver and passenger. The invention is vinyl, plastic or cardboard, rectangle shaped folder type product that is 16″ long×7″ deep. The product holds two vinyl 16″ long ½″ tubes on the top that closes the gap between bucket seats and the console of cars and trucks. The product can open to form a pocket which can also hold items no wider than one inch, safely, for easy retrieval by the driver or front seat passenger.

### CROSS REFERENCES TO RELATED APPLICATIONS

I have received a provisional patent; the provisional patent number is (U.S. 61/464,596) Attachment (I). I am requesting Domestic Priority designation as permitted under: “—35 USC 119(e) entitles applicant to the benefit of an earlier filing date for claims in a later filed application based on an earlier filed U.S. provisional application if certain conditions are met.”

### STATEMENTS REGARDING FEDERALLY SPONSORED DEVELOPMENT

Not applicable

### THE NAMES OF THE PARTIES TO A JOINT RESEARCH AGREEMENT

Not applicable

### REFERENCE TO A “SEQUENCE LISTING”

Not applicable

### BACKGROUND OF THE INVENTION

This invention pertains to suggested patent classification: 150 Purses, wallets, protective covers: Carrier Container #144—Including Expandable pocket.

The invention is a motor vehicle accessory made of vinyl, plastic or cardboard, rectangle and folder shaped product. The product is 16″ long×7″ deep, holds two vinyl tubes 16″ long×1×½″ on the top that closes the gap between bucket seats and the console of cars and trucks. The product forms a pocket which can also hold items no wider than one inch, safely, for easy retrieval by the driver or front seat passenger. The product will be sold in pairs and will be placed in the gap between the bucket seats of the driver and passenger. The vinyl tubes on top are held in place by the pressure formed by the seat and the console as the product is inserted in the gap. The vinyl tubes on top of the product are flexible and can hold items as thin as credit cards or envelopes securely on top for easy retrieval.

The invention came from solving a common problem that people face frequently in their cars and trucks when items they have with them drop in the space between the bucket seats and the console. My granddaughter and I would regularly complain to each other of how items, usually our cell phones, would fall between the bucket seats and the console and would go into the gap where they would be very difficult to retrieve. So my idea was to develop a product that would cover that space so items would not fall in while also holding items that we wanted to keep near us and would fit in the space by the pocket formed by the invention.

### BRIEF SUMMARY OF THE INVENTION

A motor vehicle accessory that is very useful in solving the problem of people dropping items in the gap between the bucket seat and console of trucks or cars. The accessory can be made of vinyl, plastic or cardboard, and is rectangle and folder shaped product. The product is 16″ long×7″ deep, holds two vinyl 16″ long by ½″ diameter tubes on the top that closes the gap between bucket seats and the console of cars and trucks. The product will be sold in pairs and will be placed in the gap between the bucket seat of the driver and passenger. The product forms a pocket which can also hold items no wider than one inch, safely, for easy retrieval by the driver or front seat passenger. The vinyl tubes on top are held in place by the pressure formed by the seat and the console as the product is inserted in the gap. The vinyl tubes on top of the product are flexible and can hold items as thin as credit cards or envelopes securely on top for easy retrieval.

### BRIEF DESCRIPTION OF THE SEVERAL VIEWS OF THE SCHEMATIC PLANS DRAWINGS

### Attachment (II). Pages 1-2.

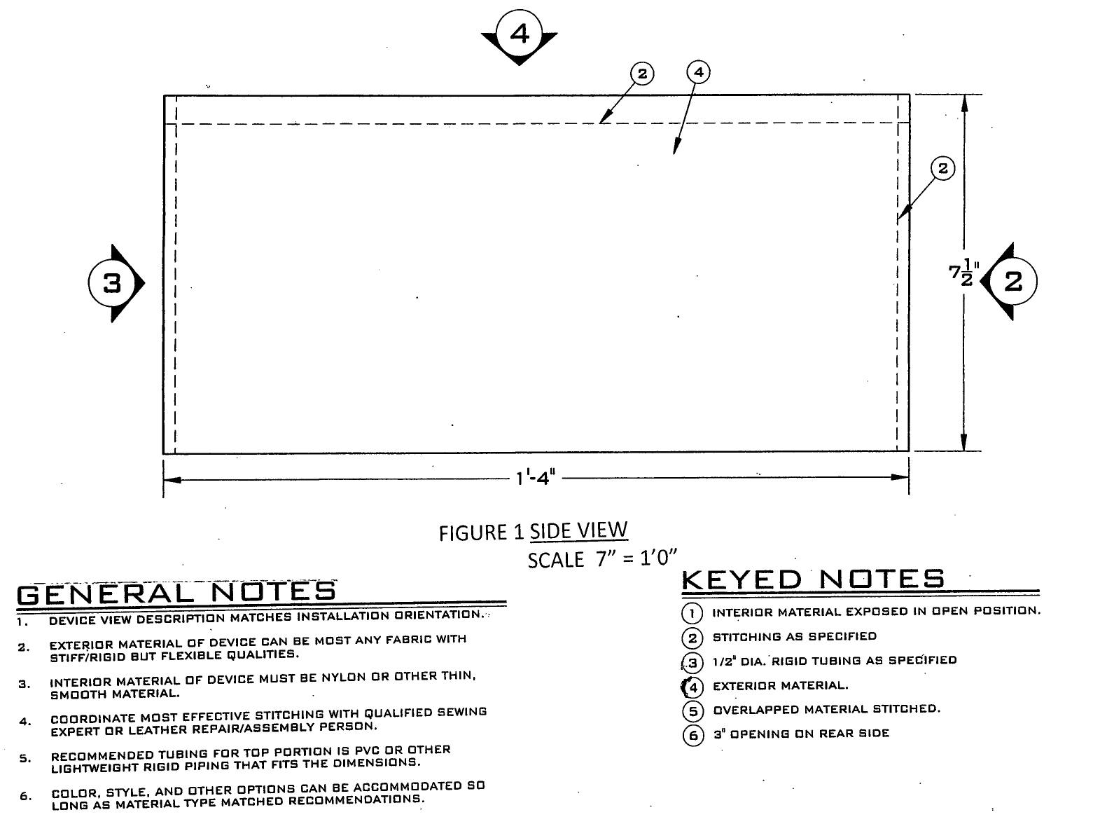

FIG. 1: Side View. Rectangle shape drawing showing dimensions of 1′4″×7½″ with pattern of sewing around the rectangle

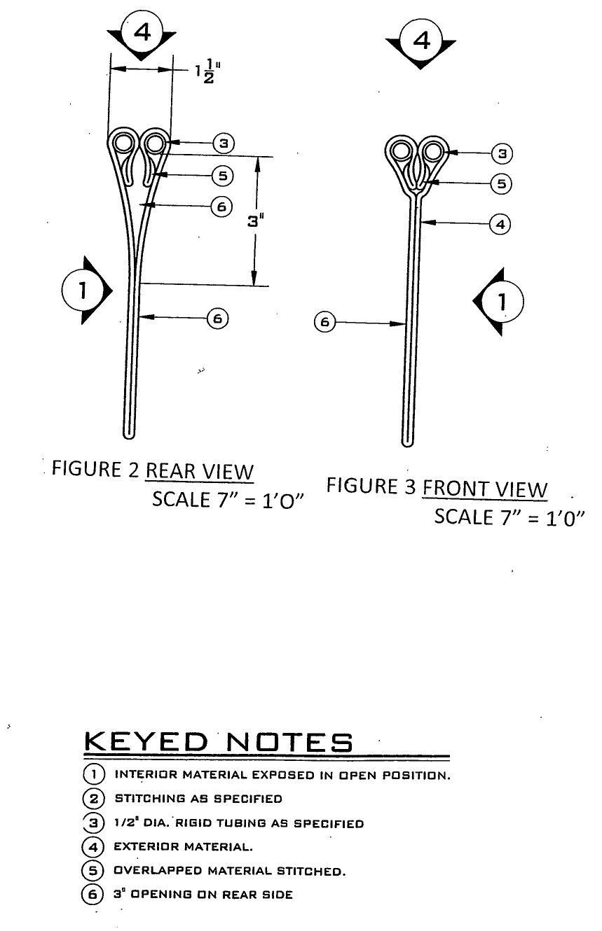

FIG. 2: Rear View. Y shaped drawing showing two circles on top, an opening below and a long closed triple line shape going down from the Y shape.

FIG. 3: Front View. Y shaped drawing showing two circles on top, and a closed long closed triple line shape going down from the Y shape.

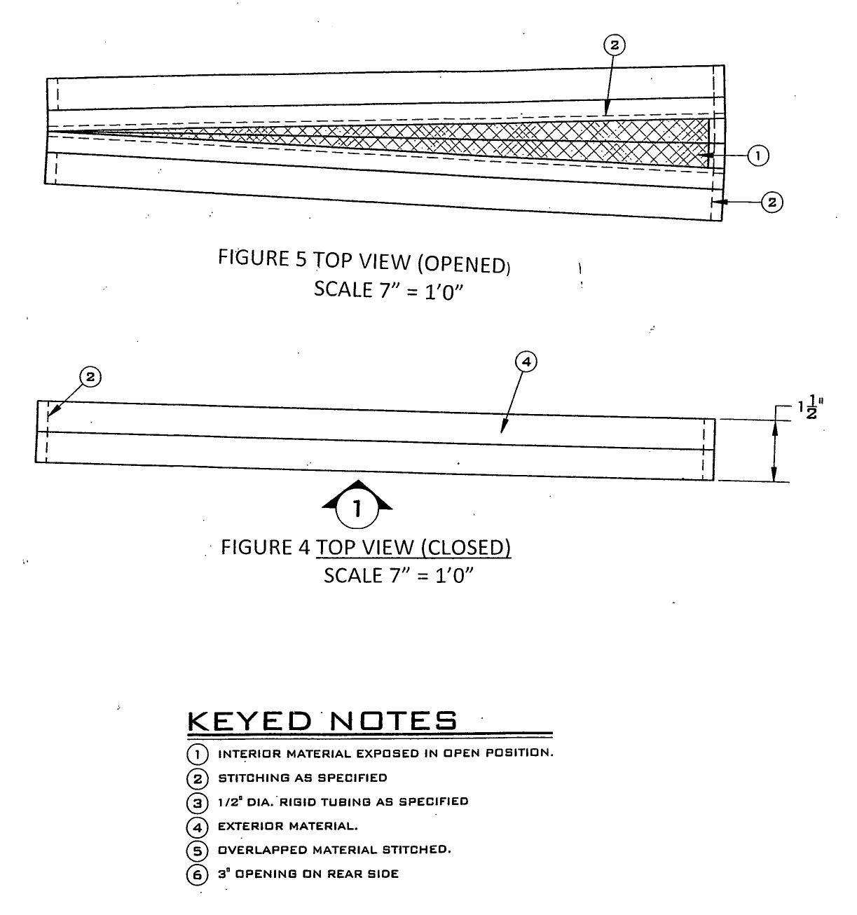

FIG. 4: Top view (closed). Two side by side long closed cylinders 1½″ wide.

FIG. 5: Top view (opened). Two side by side long cylinders 1½′ wide, closed on the left side and opened on the right side

### DETAILED DESCRIPTION OF THE INVENTION.

The invention can be made of vinyl, plastic or cardboard (VPC), covered with material, that will fill in the gap between the bucket seats of cars or trucks and the console. The product will catch items that normally fall in the gap and will carry small items that can fit in the gap. The product will be sold in pairs and will be placed in the gap between the bucket seats of the driver and passenger. The product will have sleeves at the top which will hold two vinyl tubes 16″ long by ½″ inch in diameter. The tubes will hold the product in place between the seat and the console. The product needs only to be inserted into the gap between the seat and consul and it will stay in place. The tubes can be fitted into the gap in such a way that they will cover the gap completely, but the product can be pulled up and envelopes, credit cards, cell phones etcetera can be inserted at the top to keep handy, the pressure of the tubes, seat, and console will keep them in place. Also, small items no wider than 1 inch can be placed inside the product pocket for safe keeping in the gap itself. The product will have a 3 inch opening on one side from the top; this opening will allow the seatbelt to be covered by the product. The product should be made out of one piece of (VPC) with dimension of 17 inches deep×16 inches long, the material covering the (VPC) will be 18 inches deep×17 inches long, this way there will be one half inch on all sides of the material to cover the (VPC). The 18 inches sides will be folded upon each other to form a folder. The product must be 16 inches long because this is the standard size of the gap form front to back of most bucket seats; this will cover the entire gap. The two open top parts of the VPC will be folded together with the material covering the VPC and the vinyl tubes; this will take about 2 inches of the VPC and material on each side. The material and (VPC) will be sown together on the two open sides and the sleeve covering the vinyl tubes will be sown on to the (VPC). The dimensions of the final product should be 16 inches long×7 inches deep and will fit 90% of vehicles.

This product can be covered with any sort of material which appeals to customers. It can be made in any color which matches the interior of the car or truck, it can be embossed with emblems of any kind (with the appropriate permits), and it can be specially designed with initials, rhinestones or any other customer fancy. The inside frame of the product must be made out of vinyl, plastic or cardboard (VPC) which is sturdy and durable enough to be inserted into the gap and be pulled in and out as needed. The outside material can be made out of whatever the customer desires ranging from plastic to leather, including the VPC itself without material covering.

1. This claim pertains to the schematic plans drawing of the Gap Cover Folder attachment (II) as described in the views below.
FIG. 1: Side View. Rectangle shape drawing showing dimensions of 1′4″×7½″ with pattern of sewing around the rectangle
FIG. 2: Rear View. Y shaped drawing showing two circles on top, an opening below and a long closed triple line shape going down from the Y shape.
FIG. 3: Front View. Y shaped drawing showing two circles on top, and a closed long closed triple line shape going down from the Y shape.
FIG. 4: Top view (closed). Two side by side long closed cylinders 1½″ wide.
FIG. 5: Top view (opened). Two side by side long cylinders wide, closed on the left side and opened on the right side
